(19) United States
(12) Patent Application Publication
(10) Pub. No.: US 2002/0103748 A1
(43) Pub. Date: Aug. 1, 2002

(54) System and method for consolidating financing in an internet exchange portal

(76) Inventors: Rai Abhyanker, Cupertino, CA (US); Alex Panelli, San Diego, CA (US); K. Suresh, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/774,449

(22) Filed: Jan. 30, 2001

(51) Int. Cl. G06F 17/60

(52) U.S. Cl. 705/38; 705/37

(57) ABSTRACT

A system and method for consolidating financing in a business-to-business internet exchange portal is disclosed. The method of the present invention includes the steps of receiving a set of financing applications at the internet exchange portal, generating a generic financing application from the set of applications, receiving data for the generic financing application, and populating the set of financing applications with the data. The method may also include the steps of receiving at the internet exchange portal a set of financial data from a buyer; generating a generic financing application from the set of financial data; presenting the generic financing application to lenders; and receiving a bid from one or more of the lenders for providing credit to the buyer.

### BACKGROUND OF THE INVENTION

1. Field of the Invention

The present invention relates generally to systems and methods for financing, and more particularly for consolidating financing in an internet exchange portal.

2. Discussion of Background Art

In this modern information age, an increasing number of business transactions and financial services are provided over computer networks. Internet exchange systems are one example of such “virtual” networks.

FIG. 1 is a dataflow diagram of a typical internet exchange system 100 configured to operate as an online Business-to-Business (B2B) auction. In the system 100 a buyer 102 seeks to purchase goods from a seller 104 through an exchange portal 106. Either the seller 104 or the exchange portal 106, however, require that the buyer 102 have sufficient credit to complete the purchase. Some internet exchange systems even require that buyers be pre-approved for credit before registering or bidding in an auction.

Sufficient credit is typically shown by the buyer 102 either with a “letter of credit” or a “flooring” agreement from a financing and/or flooring lender 108, 110, or 112. Letters of credit typically provide buyers with a line of credit that may be drawn upon for any purpose, and secured by an obligation of collateral from the buyers.

Flooring arrangements, while analogous to letters of credit, have a few important differences. First, flooring is typically tied to a specific planned purchase of goods by a buyer. Thus, unlike conventional letters of credit, buyers cannot use flooring to purchase office equipment or other goods or services beyond those specifically approved by the flooring lender 108, 110, or 112. Second, upon flooring approval and a purchase of goods by the buyer 102, the lender may choose to make payments directly to the seller 104 upon instructions from the buyer 102. Thus the buyer 102 never directly receives any flooring funds. Also, unlike conventional letter of credit transactions, flooring lenders may choose to retain ownership of the goods until actual and ultimate sale from the buyer 102 to an end consumer.

Flooring transactions begin when the buyer 102 submits an application for flooring credit to one or more lenders 108, 110, or 112. Typically, buyers approach each lender sequentially. Thus the buyer 102 requests, completes, and submits a first flooring application to the first lender 108, and the first lender 108 either approves or disapproves the flooring request, as shown by transaction line 114. In the alternative, the buyer 102 can choose to shop the other lenders 110 and 112 for better loan terms even if the first lender 108 approves the request.

Since, flooring applications and submissions are not standardized from lender to lender, if the buyer 102 seeks flooring from the other lenders 110 and 112, the buyer 102 then must laboriously request, complete, and submit two additional application forms for the second and third lenders 110 and 112, as shown by transaction lines 116 and 118. Similarly, these lenders 110 and 112 may either approve or disapprove the flooring request.

While buyers seek funding from one or more lenders in order to complete a single purchase transaction within the exchange 100, most buyers also seek flooring on a continual basis during each of many purchase transactions within the exchange 100. Since flooring is often awarded based on an ability of a particular buyer to sell-through sufficient volume of product, buyers and sellers participating within the exchange 100 are constantly filling out multiple forms from multiple lenders.

Within the system 100 shown, the buyer 102 has successfully negotiated flooring credit with the third lender 112. In response, the third lender 112 and the seller 104 exchange information, as shown by transaction line 120, showing that the buyer 102 has sufficient funds to complete a predetermined purchase transaction. The seller 104 and the buyer 102 also exchange acknowledgements, as shown by transaction line 122. The buyer 102 then proceeds to bid for goods within the exchange 100 over the exchange portal 106 in order to consummate a transaction with the seller 104, as shown by transaction lines 124 and 126.

The many different applications and submission procedures that buyers must follow in order to identify and select flooring lenders within the exchange 100 creates time consuming and complex inefficiencies. Such inefficiencies reduce the exchange's 100 effectiveness as a marketplace for goods and services.

In response to the concerns discussed above, what is needed is a system and method for consolidating financing in an internet exchange portal that overcomes the problems of the prior art.

### SUMMARY OF THE INVENTION

The present invention is a system and method for consolidating financing in an internet exchange portal. The method of the present invention includes the steps of receiving a set of financing applications at the internet exchange portal, generating a generic financing application from the set of applications, receiving data for the generic financing application, and populating the set of financing applications with the data.

In other aspects of the invention, the method may include the steps of consolidating similar sets of data fields in each financing application into a generic data field in the generic financing application; receiving financing applications from lenders and data for the generic financing application from buyers; and receiving offers of credit from the lenders to be used by the buyer for purchasing goods within the internet exchange portal.

In yet another aspect of the invention, the method may include the steps of receiving at the internet exchange portal a set of financial data from a buyer; generating a generic financing application from the set of financial data; presenting the generic financing application to lenders; and receiving a bid from one or more of the lenders for providing credit to the buyer.

The system and method of the present invention are particularly advantageous over the prior art because a trading internet exchange portal is combined with potential revenue streams from financing revenue flows. The present invention also simplifies steps by which buyers need to go through to obtain financing credit through a Business to Business internet exchange portal, by requiring buyers to only fill out one credit form rather than multiple ones to obtain “financing/flooring” lines that can be used to transact through an internet exchange portal. The present invention permits buyers to manage credit lines and use credit to pay for exchange purchases from within the internet exchange portal rather than access an external portal, thereby simplifying purchase through the portal. The present invention also provides a method of collecting a “transaction based” commission fees in exchange for providing lenders with an opportunity to bid for loan business from buyers. Such fee provides the portal with an incremental revenue stream.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of a typical internet exchange system;

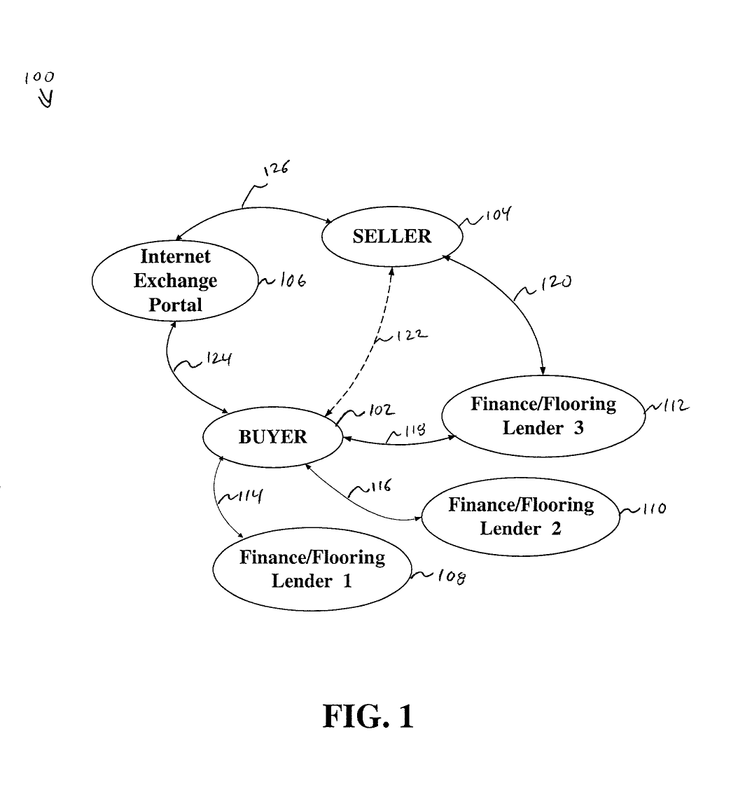

FIG. 2 is a dataflow diagram of a system for consolidating financing in a business-to-business internet exchange portal; and

FIG. 3 is a flowchart of a method for consolidating financing in an internet exchange portal.

### DETAILED DESCRIPTION OF THE PREFERRED EMBODIMENT

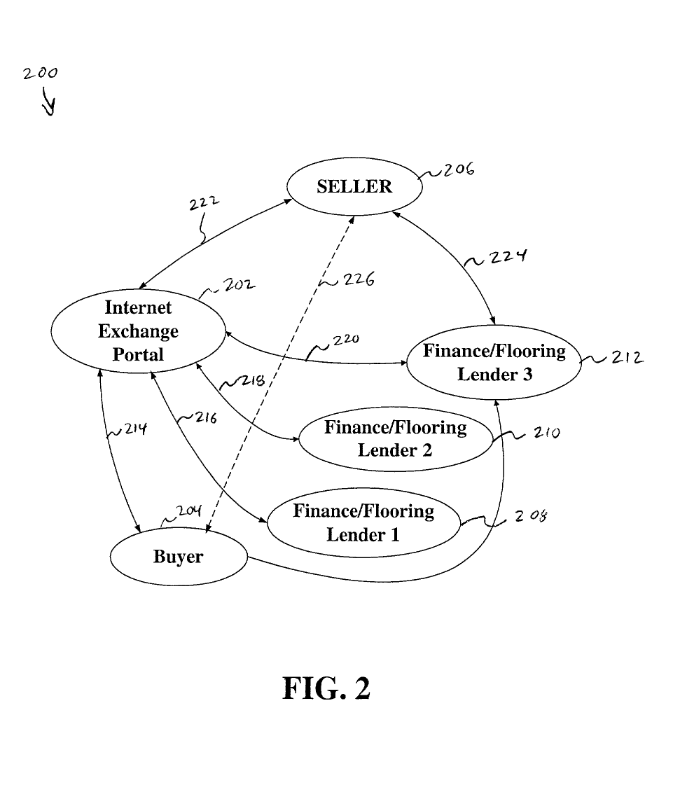

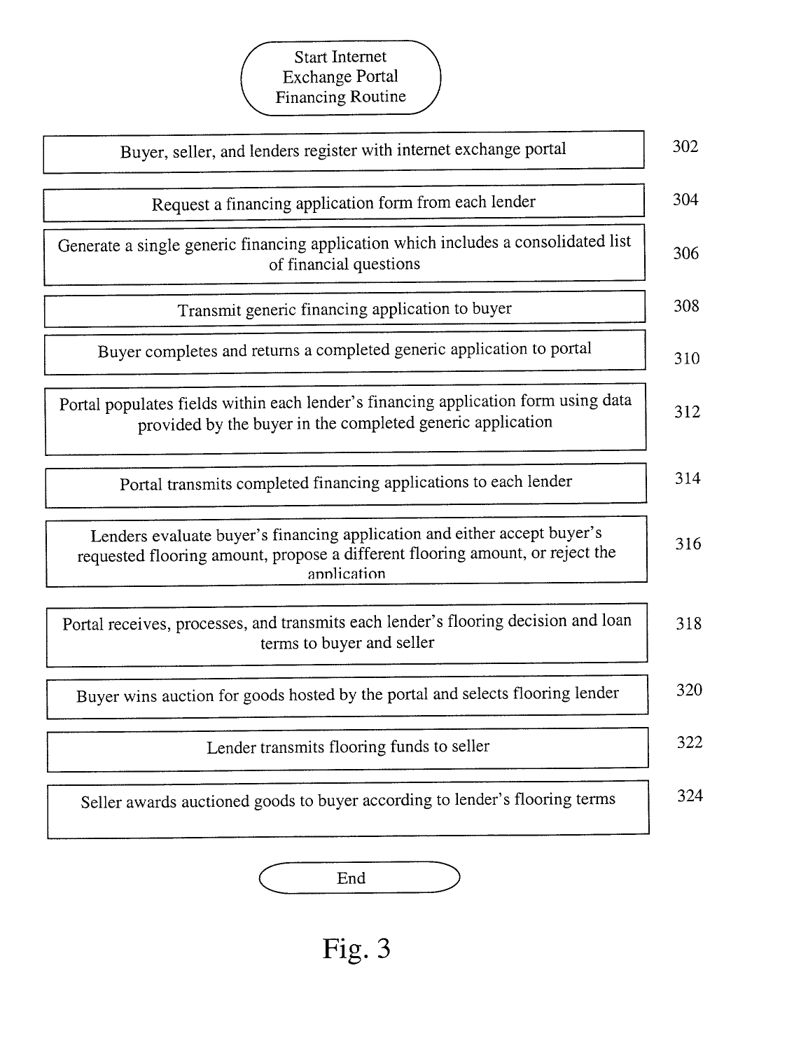

FIG. 2 is a dataflow diagram of a system 200 for consolidating financing in a Business-To-Business (B2B) internet exchange portal 202 configured to operate as an online auction for good, and FIG. 3 is a flowchart of a method 300 for doing so. A plurality of suppliers, dealers, resellers, and distributors are registered to transact business over the portal 202. The portal 202 may be configured either as a complex individual company or industry-wide supply chain in which there are rapid inventory turns and associated financial flows yielding a need for financial alignment for each transfer of physical goods. The system 200 and method 300 are discussed simultaneously below.

The method begins in step 302 where a buyer 204, a seller 206, a first lender 208, a second lender 210, and a third lender 212 communicate over lines 214 through 222 to register with the portal 202 in preparation for bidding upon, financing, and completing commercial transactions. While the present invention is discussed with respect to a single buyer, seller, and three lenders, those skilled in the art recognize that the present invention scales to any number of buyers, sellers, and lenders. Also, while the present invention is discussed below with respect toward using the portal 202 to obtain flooring for the buyer 204, those skilled in the are recognize that the present invention can also be used to obtain any sort of financial product for the buyer 204, including lines or letters of credit.

The lenders 208, 210, and 212 are sometimes labeled commercial transaction companies, and include for example, Deutsche Financial Services, TransAmerica, Bank of America, IBM Financial Services, and Finova Capital, to name just a few. As part of registration in step 302, the lenders 208, 210, and 212 enter agreements with the portal 202 and the seller 206 to transact business though the portal 202. In step 304, the portal 202 requests a financing application form from each of the lenders 208 through 212 over lines 216, 218 and 220 respectively. Each financing application form includes a set of fields for the buyer 204 to populate which enable the lenders to decide whether or not to provide flooring.

The portal 202, in step 306, then generates a single generic financing application form which includes a consolidated set of fields for the buyer 204 to populate. The consolidated list of fields combines data fields common to each financing application, such as contact information, and appends any unique data fields which are specific to a particular lender's application form. Thus, while every lender financing application may ask for contact information from the buyer 204, the generic financing application form asks the buyer 204 for contact information only once. Field consolidation thus saves the buyer 204 a significant amount of time.

The generic financing application form can be further modified with additional fields specific to the method of the present invention. Such additional fields can include fields for registering the buyer 204 with the internet exchange portal, as discussed with respect to step 302, and/or can asking the buyer 204 to select which lenders flooring is to be requested from.

In step 308, the portal 202 transmits the generic financing application form over line 214 to the buyer 204 for completion. The buyer 204, in step 310, returns a completed generic application form to the portal 202 over line 214, which is then stored by the portal 202. In step 312, the portal 202 uses the completed generic application form to populate the fields within each lender's financing application form requested in step 304. Next, in step 314, the portal 202 transmits completed financing application forms back to each respective lender over lines 216, 218, and 220.

In step 316, each lender 208, 210, and 212 evaluates the buyer's 204 financing application and either accepts the buyer's 204 requested flooring amount, proposes a different flooring amount, or rejects the buyer's 204 request for flooring.

In step 318, the portal receives, processes, and transmits each lender's 208, 210, and 212 flooring decision and loan terms to the buyer 204 over line 214 to the seller 206 over line 222. Thus, the buyer 204 and seller 222 are notified that the buyer 204 has been approved for transacting over an internet exchange portal and that the buyer 204 has a predetermined amount of available flooring credit from each of the lenders 208, 210, and 212. The flooring credit is represented both separately and aggregately. The portal 202 also renders a set of individualized hyperlinked logos for each lender which has awarded credit on the buyer's 204 portal logon page.

In step 320, the buyer 204 successfully wins a bid on an auction for goods hosted by the portal 202 and selects the third lender 212 for flooring. In response, the third lender 212 directly transmits flooring funds to the seller 206 over line 224, in step 322, and the seller 206 awards the auctioned goods to the buyer 204 over line 226, according to the third lender's 212 flooring terms, in step 324.

In an alternate embodiment of the present invention, the buyer 204 give the portal 202 permission to provide buyer's credit information and history to unsolicited lenders which the buyer 204 has not solicited for credit and/or the buyer may not even be aware of. Such unsolicited lenders can then contact the buyer directly with an offer to provide flooring or other credit in anticipation of future commercial transactions over the portal 202 by the buyer.

In another alternate embodiment of the present invention, the portal 202 provide a financing auction between lenders which parallels the auction for goods between buyers and sellers. The portal 202 can provide lenders with a list of buyers in need of financing which the lenders may then bid upon for loan business. The portal 202 can charge a “transaction based” commission fee for providing lenders this financial opportunity.

While one or more embodiments of the present invention have been described, those skilled in the art will recognize that various modifications may be made. Variations upon and modifications to these embodiments are provided by the present invention, which is limited only by the following claims.

What is claimed is:

1. A method for consolidating financing in an internet exchange portal, comprising the steps of:
receiving a set of financing applications at the internet exchange portal;
generating a generic financing application from the set of applications;
receiving data for the generic financing application; and
populating the set of financing applications with the data.

2. The method of claim 1, wherein:
the receiving a set step includes the step of receiving a set of financing applications each including a set of data fields; and
the generating step includes the step of consolidating similar sets of data fields in each financing application into a generic data field in the generic financing application.

3. The method of claim 1, wherein:
the receiving a set step includes the step of receiving a set of financing applications from a corresponding set of lenders; and
the receiving data step includes the step of receiving data from a buyer.

4. The method of claim 3 further comprising the steps of:
transmitting the set of financing application to the lenders; and
receiving a set of financing responses from the lenders including credit available to the buyer for purchasing goods within the internet exchange portal.

5. The method of claim 4 further comprising the steps of:
receiving from the buyer an offer to purchase goods from the seller over the portal;
receiving from a seller an acceptance of the offer; and
instructing the set of lenders to provide a particular amount of credit to the buyer as consideration for the goods.

6. The method of claim 5 wherein the instructing step includes the step of:
instructing the set of lenders to provide a particular amount of flooring to the buyer.

7. A method for consolidating financing in an internet exchange portal, comprising the steps of:
receiving at the internet exchange portal a set of financial data from a buyer;
generating a generic financing application from the set of financial data;
presenting the generic financing application to a set of lenders; and
receiving a bid from one of the set of lenders for providing credit to the buyer.

8. The method of claim 7 further comprising the step of:
charging a transaction based commission fee for each bid.

9. A computer-usable medium embodying computer program code for causing a computer to consolidate financing in an internet exchange portal, comprising the steps of:
receiving a set of financing applications at the internet exchange portal;
generating a generic financing application from the set of applications;
receiving data for the generic financing application; and
populating the set of financing applications with the data.

10. The computer-usable medium of claim 9, wherein:
the receiving a set step includes the step of receiving a set of financing applications each including a set of data fields; and
the generating step includes the step of consolidating similar sets of data fields in each financing application into a generic data field in the generic financing application.

11. The computer-usable medium of claim 9, wherein:
the receiving a set step includes the step of receiving a set of financing applications from a corresponding set of lenders; and
the receiving data step includes the step of receiving data from a buyer.

12. The computer-usable medium of claim 11 further comprising the steps of:
transmitting the set of financing application to the lenders; and
receiving a set of financing responses from the lenders including credit available to the buyer for purchasing goods within the internet exchange portal.

13. The computer-usable medium of claim 12 further comprising the steps of:
receiving from the buyer an offer to purchase goods from the seller over the portal;
receiving from a seller an acceptance of the offer; and
instructing the set of lenders to provide a particular amount of credit to the buyer as consideration for the goods.

14. The computer-usable medium of claim 13 wherein the instructing step includes the step of:
instructing the set of lenders to provide a particular amount of flooring to the buyer.

15. A computer-usable medium embodying computer program code for causing a computer to consolidate financing in an internet exchange portal, comprising the steps of:
receiving at the internet exchange portal a set of financial data from a buyer;
generating a generic financing application from the set of financial data;
presenting the generic financing application to a set of lenders; and
receiving a bid from one of the set of lenders for providing credit to the buyer.

16. The computer-usable medium of claim 15 further comprising the step of:
charging a transaction based commission fee for each bid.

17. A system for consolidating financing in an internet exchange portal, comprising:
means for receiving a set of financing applications at the internet exchange portal;
means for generating a generic financing application from the set of applications;
means for receiving data for the generic financing application; and
means for populating the set of financing applications with the data.

18. The system of claim 17, wherein:
the means for receiving a set includes means for receiving a set of financing applications each including a set of data fields; and
the means for generating includes means for consolidating similar sets of data fields in each financing application into a generic data field in the generic financing application.

19. The system of claim 17, wherein:
the means for receiving a set includes means for receiving a set of financing applications from a corresponding set of lenders; and
the means for receiving data includes means for receiving data from a buyer.

20. The system of claim 19 further comprising:
means for transmitting the set of financing application to the lenders; and
means for receiving a set of financing responses from the lenders including credit available to the buyer for purchasing goods within the internet exchange portal.

21. The system of claim 20 further comprising:
means for receiving from the buyer an offer to purchase goods from the seller over the portal;
means for receiving from a seller an acceptance of the offer; and
means for instructing the set of lenders to provide a particular amount of credit to the buyer as consideration for the goods.

22. The system of claim 21 wherein the means for instructing includes:
means for instructing the set of lenders to provide a particular amount of flooring to the buyer.

23. A system for consolidating financing in an internet exchange portal, comprising:
means for receiving at the internet exchange portal a set of financial data from a buyer;
means for generating a generic financing application from the set of financial data;
means for presenting the generic financing application to a set of lenders; and
means for receiving a bid from one of the set of lenders for providing credit to the buyer.

24. The system of claim 23 further comprising:
means for charging a transaction based commission fee for each bid.
